(19) United States
(12) Patent Application Publication
(10) Pub. No.: US 2010/0240404 A1
(43) Pub. Date: Sep. 23, 2010

(54) PERSONAL LOCATION MONITORING SYSTEM AND RELATED DEVICES AND METHODS

(76) Inventor: Rachael Marie Caire McCrosky, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/727,876

(22) Filed: Mar. 19, 2010

Related U.S. Application Data
(60) Provisional application No. 61/210,527, filed on Mar. 20, 2009.

(51) Int. Cl. H04W 4/12; G08B 1/08

(52) U.S. Cl. 455/466; 340/539.13

(57) ABSTRACT

A personal location monitoring system includes a personal locator device and remote location reporting device. The personal locator device includes a portable housing, a wireless communications unit configured to communicate text messages over a wireless communications network, a position determining unit configured to receive position signals from a positioning system, and a processor in signal communication with the wireless communications unit and the position determining unit. The processor is configured to receive a position determination text message via the wireless communications unit, and send at least one position reporting text message via the wireless communications unit responsive to the position determination text message including position data based on the position signals received by the position determining unit. The remote location reporting device is configured to send the position determination text message and to receive the at least one position reporting text message.

### CROSS-REFERENCE TO RELATED APPLICATION

This application claims the benefit of U.S. Provisional Application Ser. No. 61/210,527, filed on Mar. 20, 2009, the contents of which are hereby incorporated by reference in their entirety.

### FIELD OF THE INVENTION

The present invention relates to locator devices carried by humans and animals, and to systems and methods for using such devices.

### BACKGROUND OF THE INVENTION

One of life's greatest trials is for a loved one to go missing, whether as a result of abduction, becoming lost, or due to the chaos resulting from natural or man-made disasters. For example, in the aftermath of Hurricane Katrina thousands of beloved pets and other animals went missing all along the Gulf Coast. Rescue of these animals and reunification with their owners, including prolonged efforts by the present inventor, were greatly hampered by the lack of locator devices that could have facilitated search efforts.

Despite the virtually global availability of accurate position signals from positioning systems, such as the satellite-based Global Positioning System (GPS), devices that utilize such signals are ill suited for use as personal locators. For example, such devices tend to be large and bulky, difficult for the non-tech savvy to use, and require excessive power consumption. While such devices may include rechargeable batteries, there is no way to predict when in the battery discharge cycle the human or animal will go missing. Most GPS devices, even if fully charged initially, will lack sufficient power to operate for more than a day or two. However, in large scale disasters recovery efforts may well extend into weeks; this is well beyond the likely battery capacity of such devices.

In addition to being unsuited for individual use, commercially-available tracking systems often involve specialized, proprietary interfaces that require users to pay ongoing subscription fees. As a result, even were such systems to employ devices that could be easily and usefully carried by humans or animals, such systems would be cost prohibitive for a large number of prospective users.

### SUMMARY OF THE INVENTION

In view of the foregoing, it is an object of the present invention to provide an improved personal location monitoring system, and related devices and methods. According to an embodiment of the present invention, a personal location monitoring system includes a personal locator device and remote location reporting device. The personal locator device includes a portable housing, a wireless communications unit carried by said portable housing and configured to communicate via text messages over a wireless communications network, a position determining unit carried by said portable housing and configured to receive position signals from a positioning system, and a processor carried by said portable housing and in signal communication with the wireless communications unit and the position determining unit.

The processor is configured to receive a position determination text message via the wireless communications unit, and to send at least one position reporting text message via the wireless communications unit responsive to the position determination text message including position data based on the position signals received by the position determining unit.

The remote location reporting device is configured to send the position determination text message, and to receive at least one position reporting text message. According to an aspect of the present invention, the remote location reporting device is a personal electronics device, such as a cellular telephone.

According to a method aspect of the present invention, a method of using a personal locator device includes receiving, over a wireless network, a position determination text message at the personal locator device, determining position data from position signals received at the personal locator device, generating a position reporting text message in response to the position determination message including the position data, and sending the position reporting text message over the wireless network.

These and other objects, aspects and advantages of the present invention will be better appreciated in view of the drawings and following detailed description of a preferred embodiment.

### BRIEF DESCRIPTION OF THE DRAWINGS

FIG. 1 is a schematic overview of a personal location monitoring system, including a personal locator device and a remote location reporting device, according to an embodiment of the present invention;

FIG. 2 is a schematic perspective view of the personal locator device of FIG. 1;

FIG. 3 is a partially exploded, schematic perspective view of the personal locator device of FIG. 1;

FIG. 4 is a schematic circuit diagram of the personal locator device of FIG. 1;

FIG. 5 is a schematic circuit diagram of the personal locator device of FIG. 1, including a first set of expansion devices;

FIG. 6 is a schematic circuit diagram of the personal locator device of FIG. 1, including a second set of expansion devices;

FIG. 7 is a flow diagram of a method for remotely determining the location of a user, according to a method aspect of the present invention; and

FIG. 8 is a text message table for use in connection with the system of FIG. 1 and method of FIG. 7.

### DETAILED DESCRIPTION OF A PREFERRED EMBODIMENT

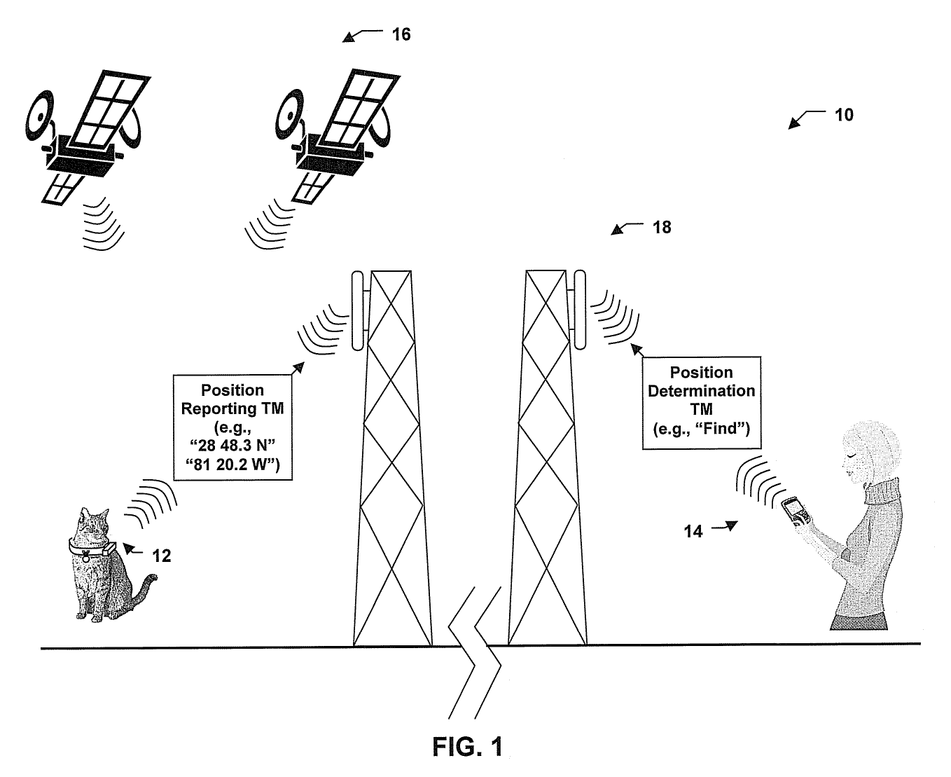

Referring to FIG. 1, personal location monitoring system 10 includes a personal locator device 12 and a remote location monitoring device 14. As used herein, the terms “person,” “personal” and “user” refer generically to a human or animal. The personal locator device is configured to receive position signals from a positioning system 16, such as GPS, and to send and receive wireless communications over a wireless communications network 18, such as the Global System for Mobile communications (GSM) network. The remote location monitoring device 14 is also configured to send and receive messages over the wireless communications network 18. In particular, the devices 12, 14 are configured to send and receive position determination and position reporting text messages over the communications network 18, such as short message service (SMS) text messages.

While the utilization of GSM networks to send and receive SMS text messages is particularly advantageous due to the international availability of GSM and SMS, other networks and message formats can be used. Additionally, it will be appreciated that, while the personal locator device 12 is configured to wirelessly communicate directly with some component of the network 18, the remote location monitoring device 14 can communicate indirectly with the network 18. For example, the remote location monitoring device 14 can be a personal computer which communicates with the network 18 through one or more wired communications networks, such as the public-switched telephone network (PSTN) or a cable network.

Advantageously, the remote location monitoring device 14 can be a wireless communication device, such as a cellular telephone or other cellular-capable personal electronic device. It will also be appreciated that multiple devices 14 could be employed to send and receive text messages in connection with a given personal locator device 12. Security measures can also be implemented to prevent unauthorized individuals from querying the personal locator device 12. For instance, the personal locator device 12 can be configured to only act on messages from predetermined phone numbers, or password protection can be used. Also, the remote location monitoring device 14 can include an application, such as a mapping program, that visually represents the position of the personal locator device 12.

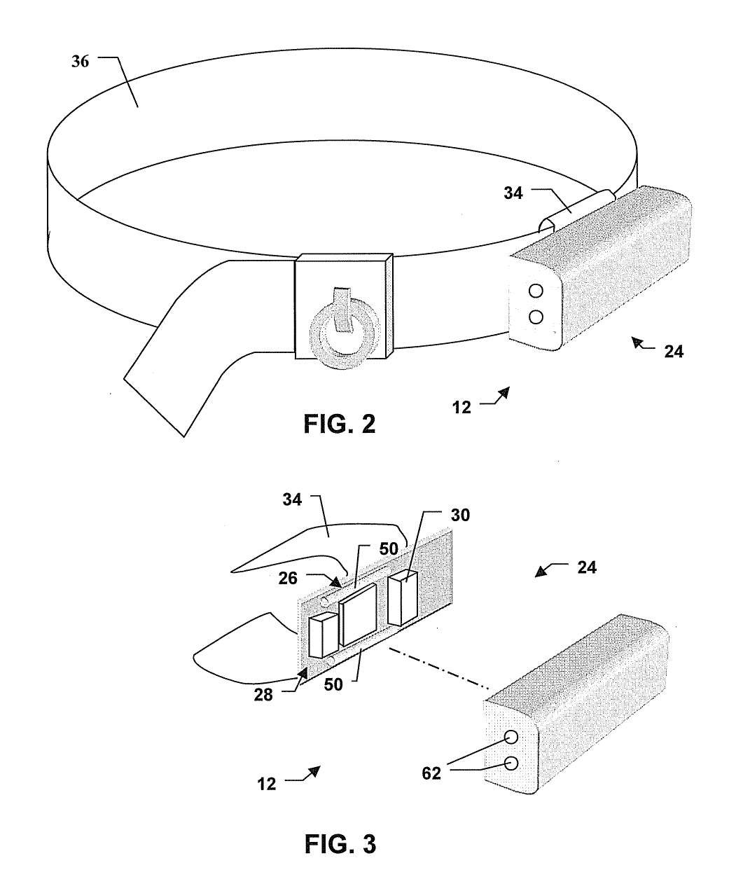

Referring to FIGS. 2 and 3, the personal locator device 12 includes a portable housing 24 that carries control electronics 26, power electronics 28 and an expansion bus 30. “Housing” as used herein generically refers to a structure that carries components of the personal locator device, and does not necessarily require an enclosed housing, and provided the housing is adapted to be carried by a user, does not necessarily require a particular shape or dimensions.

In FIG. 2, the portable housing 24 is releasably connected by a strap 34 to a pet collar 36. Preferably the strap 34 securely attaches the housing 24 to the collar 36, such that the housing 24 does not slide or rotate relative thereto. The strap 34 can be detachable from the housing 24. Additionally, the strap 34 can be equipped with one or more releasable fasteners, such as snaps or rivets that connect the strap 34 to the collar 36. It will be appreciated, however, that the present invention is not necessarily limited to housings adapted to be carried on collars. For instance, portable housings can be configured for attachment to, or integrated into, various other items that would be worn or carried by a user including, for example, belts, clothing, stuffed animals, backpacks, shoes and hats.

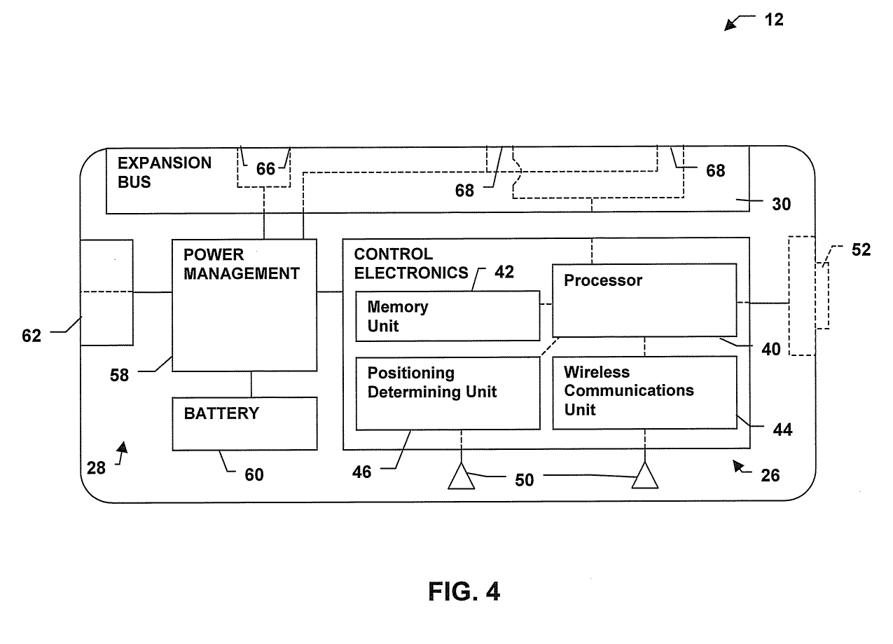

Referring to FIGS. 3 and 4, the control electronics 26 include a processor 40, a memory unit 42, a wireless communications unit 44 and a position determining unit 46. The wireless communications unit 44 and position determining unit 46 have respective antenna elements 50. It will be appreciated that the control electronics 26 are depicted schematically, and that the present invention is not necessarily limited to a particular number, type or configuration of control electronics. For example, the processor 40, memory unit 42 and wireless communications unit 44 could be derived from standard control electronics of a cellular telephone, adapted to receive inputs from the positioning system unit 46. Additionally, the processor 40 could include respective separate processors for the wireless communications unit 44 and the positioning system unit 46.

The processor 40 is in signal communication with the memory unit 42, wireless communications unit 44 and positioning system unit 46. Based on program commands and data stored in the memory unit 42, the processor 40 is configured to receive position determination messages from the wireless communications unit 44, and generate and send at least one position reporting text message via the wireless communications unit 44 including position data based on the position signals received by the position determining unit 46. As will be explained in greater detail below, the processor 40 can be configured to take additional actions in response to other text messages, as well as perform repeated actions in response to a single text message.

The wireless communications unit 44 is configured to communicate text messages over the wireless communications network 18. Preferably, the wireless communications unit 44 is configured to communicate text messages in one or more formats over one or widely available networks; such as SMS text messages over GSM networks. The wireless communications unit 44 preferably accepts a subscriber identity module (SIM) card, and different SIM cards can be used depending on the general geographic location of the user. Memory storage space on the SIM cards can also be utilized by the memory unit 42. Advantageously, SIM cards for prepaid service are used so that charges are only accrued as the system is actually used and no recurring subscription fee is needed. Since the system can communicate exclusively with text messaging, prepaid services charging lower fees for text messaging are preferred.

To minimize power consumption, the wireless communications unit 44 preferably defaults to an energy saving state wherein wireless connectivity is only established at intermittent intervals to check for text messages, rather than continuously maintaining connectivity. Upon receipt of predetermined text messages, the wireless communications unit can shorten the interval or shift to maintaining continuous connectivity. For example, the wireless communications unit 44 can normally connect with the wireless network 18 once every ten minutes, but connect every minute after a receipt of a position determination text message.

The position determining unit 46 is configured to receive position signals from the positioning system 16. Preferably, the position determining unit 46 is configured to receive GPS signals, but the position determining unit can be configured to receive position signals from other positioning systems other than, or in addition to, GPS. Non-exclusive examples of other satellite systems include the Russian Global Navigation Satellite System (GLONASS) and the Galileo system planned by the European Union. Also, the position determining unit 46 can also be configured to receive signals from terrestrial radio navigation systems, such as Long Range Navigation (LORAN) and VHF Omni-directional Radio Range (VOR). Additionally, the position determining unit 46 can receive differential GPS (DGPS) signals from corresponding ground stations.

To maximize power conservation, the position determining unit 46 preferably only initiates a position determination when directed by the processor 40 in response to receipt of a position determination text message. Alternately, the position determining unit 46 can initiate position determinations at predetermined intervals and store the most recent position data. As a result, approximate position data can be included in a position reporting text message even if a position determination text message is received when the position determining unit 46 is unable to acquire position signals; for instance, if the user is indoors. The position reporting text message can also include an indication that the position data is not current.

Preferably, the position data included in position reporting text messages by the processor 40 includes location coordinates based on the position signals. For example, the position data can include a latitude and longitude, or a range and bearing from a known location. Alternately, to minimize processing requirements for the personal locator device 12, the position data can be a textual encoding of the information in the position signals. The remote location monitoring device 14 can then be configured to decode the encoded position signal information and determine the location coordinates.

The personal locator device 12 can also include a panic button 52 in signal communication with the control electronics 26. The panic button 52 is particularly useful where the locator device 12 is carried by a human user. Upon receiving an input from the panic button 52, the processor 40 is configured to initiate a position determination, and then generate and transmit a position reporting message, preferably further including a textual indication that the user is in distress.

The power electronics 28 include a power management module 58 and a battery 60. The power management module 58 receives power inputs from the battery 60 and any other power supplies, and generates regulated power outputs suitable for the control electronics 26 and any other device components. The power management module 58 and battery 60 can be combined in a single, solid-state device, with the battery being formed by multiple low energy cells, allowing use with poorly regulated power supplies, such as photovoltaic cells, kinetic energy harvesters and thermal energy converters. Lithium polymer-type micro-cell batteries are preferred, although other battery types can be used, and the term “battery” can include long-term capacitive energy storage devices, as well. The power electronics 28 preferably also include recharging contacts 62 to allow connection of the personal locator device 12 with an external power source for battery charging.

The processor 40 can be further configured to interface with the power management module 58 to determine a power status in response to a power determining text message. The processor 40 then generates and sends a power reporting text message including, for example, battery charge percentage or approximate battery life remaining.

The expansion bus 30 includes a plurality of expansion ports 66, 68 pre-wired to accommodate expansion devices. The expansion ports 66 are pre-wired to connect power expansion devices with the power electronics 28. The expansion ports 68 are pre-wired to connect function expansion devices with the control electronics 26 and the power electronics 28. Preferably, the expansion devices are carried in or on the housing 24.

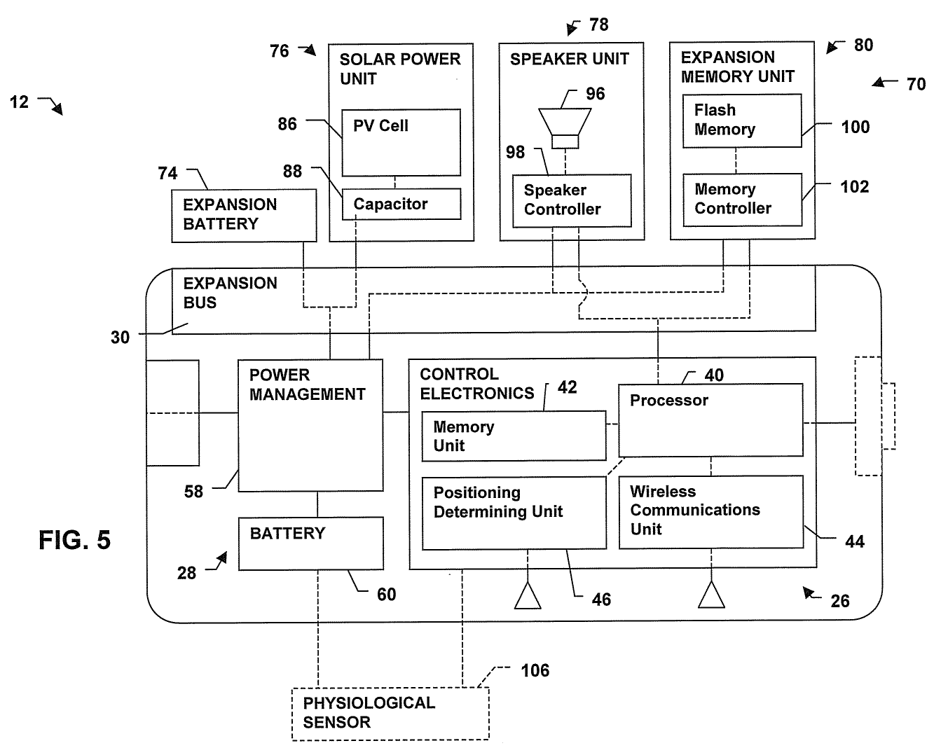

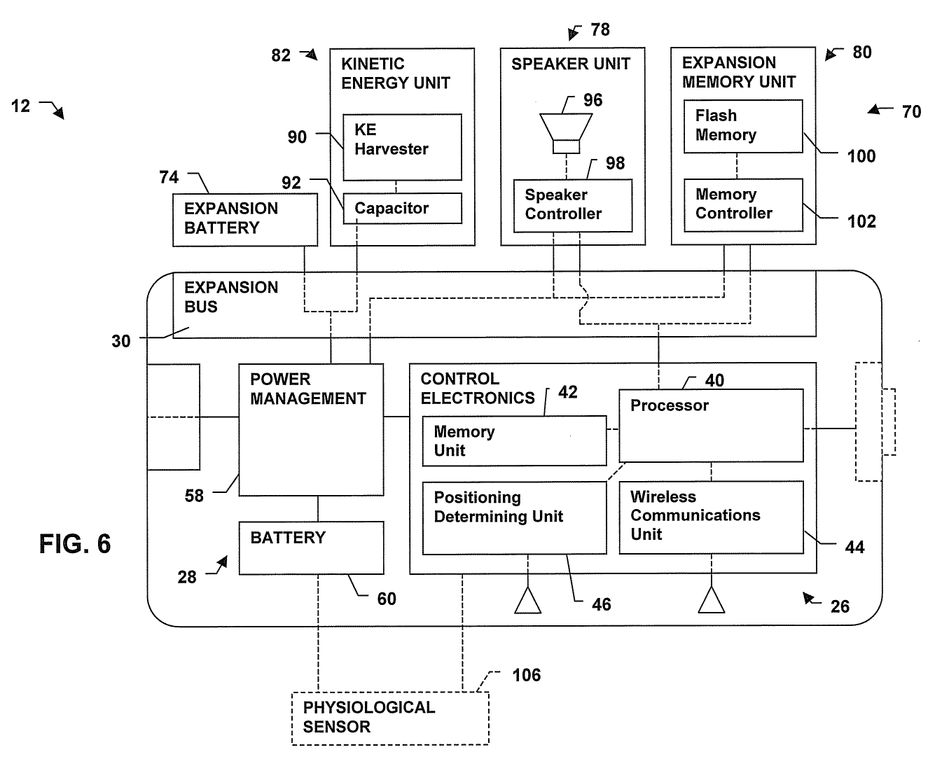

For example, referring to FIG. 5, a plurality of expansion devices 70 have been added to the personal location device 12 via connection to the expansion bus 30. The expansion devices 70 include an expansion battery 74, a solar power unit 76, a speaker unit 78 and an expansion memory unit 80. It will be appreciated that the present invention is not necessarily limited to these expansion devices, and that other expansion devices can be used. For instance, referring to FIG. 6, the solar power unit 76 is replaced with a kinetic energy unit 82. Additionally, the present invention is not necessarily limited to a particular number or combination of expansion devices. For example, any of the expansion devices 70 could be added individually, only power expansion devices, such the expansion battery 74 and solar power unit 76, could be added, or only function expansion devices, such as the speaker unit 78 and expansion memory unit 80, could be added. Further, it will be appreciated that the functional elements of one or more expansion devices 70 could be permanently incorporated into the personal locator device 12.

The expansion battery 74 connects to the power management module 58, thereby increasing power storage capacity and battery life. The expansion battery 74 can be substantially identical to the battery 28 or a different battery type can be selected.

The solar power unit 76 (FIG. 5) includes one or more photovoltaic (PV) cells 86 to convert light into electrical energy, which is then supplied to the power management module 58. A capacitor 88 can be added between the PV cell 86 and the power management module 58 to facilitate trickle charging. Preferably, power generated by the solar power unit 76 is used by the power management module 58 for battery charging, but can also be used for immediate power needs of the control electronics 26 and other devices.

The kinetic energy unit 82 (FIG. 6) includes a kinetic energy harvester 90 to convert the motion of the user into electrical energy, which is then supplied to the power management module 58. A capacitor 92 can be added between the kinetic energy harvester 90 and the power management module 58 to facilitate trickle charging, as in the solar power unit 76. Also similar to the solar power unit 76, the kinetic energy unit 82 is preferably used only for battery charging, but could also be used to supply immediate energy needs.

The speaker unit 78 includes a speaker 96 and a speaker controller 98. The speaker 96 and controller 98 are powered by the power management module 58 and operable to generate audible indications as directed by the processor 40. The speaker controller 98 can include, for example, a digital-to-analog (D/A) converter and an amplifier. Alternately, some or all functions of the speaker controller 98 could be integrated into the control electronics 26. For instance, the control electronics could include a D/A converter. Also, depending on operational requirements, the speaker unit 78 could include a simple piezo-electric device that did not require power apart from the input signal.

The expansion memory unit 80 can supply additional data storage, as well as additional program files, expanding both the effective memory storage of the personal locator device 12 and the range of functions achievable thereby. The expansion memory unit 80 includes flash memory 100 and a memory controller 102. The flash memory 100 and memory controller 102 can be part of a single unit, as in a universal serial bus (USB) drive, or the flash memory 100 can be located on a removable card, and the memory controller 102 coupled with a card reader. Other memory formats are also possible. Additionally, the memory controller 102 can be integrated into the control electronics 26, such that a separate memory controller is not needed. The expansion memory unit 80 can be connected to a personal computer or other device to allow personalization of the personal locator device 12. For instance, the text content of various text messages, including both text messages to be sent and received by the personal locator device 12, responses could be customized.

The expansion memory unit 80 can store a plurality of audio files mapped to predetermined text messages, with the processor 40 further configured to receive audible indication text messages via the wireless communications unit 44. In response to the audible indication text messages, the processor 40 can cause the speaker unit 78 to play the corresponding audio files from the expansion memory unit 80. As with the text messages, the audio files could also be customized, and new audio files could be recorded or downloaded.

The expansion memory unit 80 can further include a plurality of user status reporting messages. The processor 40 can be further configured to generate and send the status reporting text messages in response to status determination text messages received via the wireless communications unit 44. The status reporting text messages can be randomly selected as a novelty. For example, status reporting text messages for an animal user can be randomly selected to indicate “I feel happy,” “I am napping”, “Meow” or the like in response to status determination text messages.

Alternately, the personal locator device can include a physiological sensor 106 arranged on the user to perform one or more physiological measurements, such as vital signs measurements, like body temperature, heart rate and the like. The processor 40 can be further configured to include the physiological measurement in corresponding status reporting text messages. Alternately, ranges of physiological measurements can be mapped to predetermined text messages. For example, if a normal heart rate is detected, the processor can transmit “I am calm” in a status reporting text message. If an accelerated heart rate is detected, the processor can transmit “I am excited” in a status reporting text message.

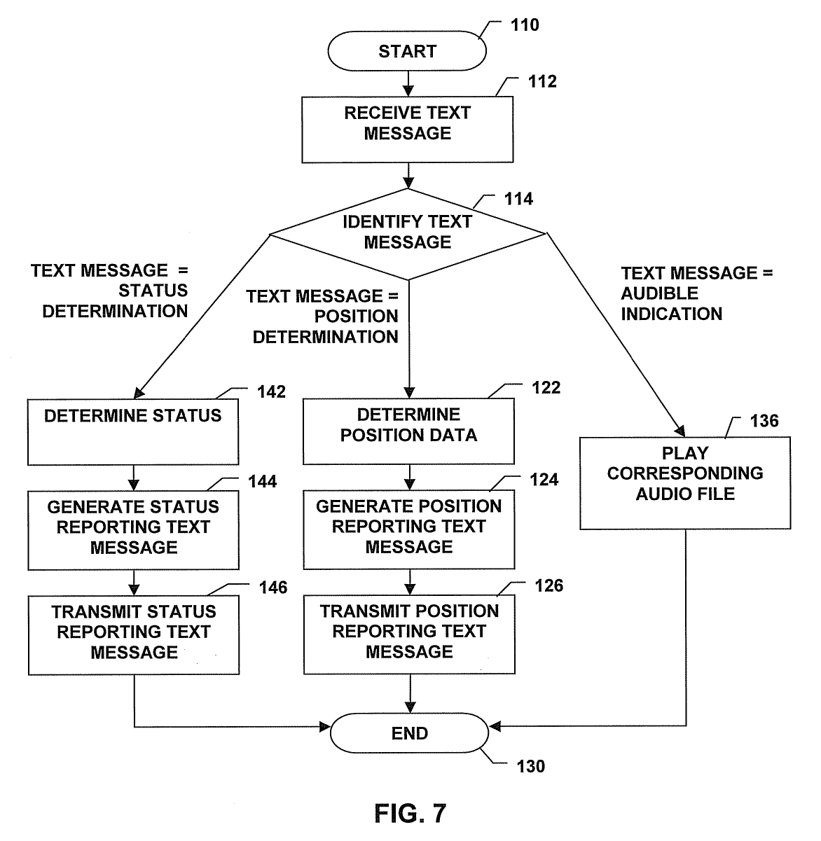

Referring to FIG. 7, according to a method aspect of the present invention, a method for using a personal locator device begins at block 110. At block 112, the personal locator device receives a text message. At block 114, where the personal locator device can receive multiple text message types, the personal locator device identifies the text message type.

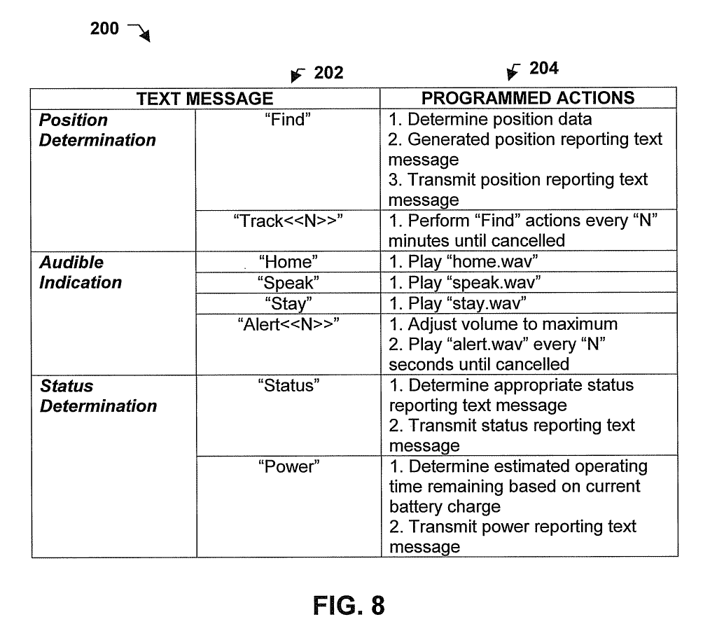

Referring to FIG. 8, the personal locator device includes a text message table 200, mapping a plurality of text messages 202 to respective actions 204. To identify the received text message, the personal locator device compares the text content of the received text message to the table 200. In general, the text messages fall into three categories, position determination text messages, audible indication text messages and status determination text messages. Preferably, the text messages include words related to the actions desired to be taken. However, for expediency, the text messages could include brief letter or number combinations, or even single letters or numbers.

Additionally, multiple text messages can be mapped to the same actions; for instance, “find” and “locate” can both be treated as single position determination text messages. Also, the personal locator device can be configured to accommodate typographical errors and misspellings by identifying a text message that does not appear in the table with the closest text message that does. Furthermore, the personal locator device can be configured to generate and send an error text message to indicate that a previous text message was not understood.

Referring again to FIG. 7, the personal locator device will take different actions depending on the text message identified at block 114. If the text message is a position determination text message, the personal locator device determines position data 122. As described above, the position data is based on position signals from a positioning system and preferably includes location coordinates. At block 124, a position reporting text message is generated including the position data, and at block 126, the position reporting text message is transmitted. The method ends at block 130, unless a subsequent text message is received or a repetition of the preceding steps is dictated by the position determining text message.

For example, referring again to FIG. 8, upon receiving a “Find” position determination text message, the personal locator device is programmed to take the actions in blocks 122-126 a single time. However, a “Track<<N>>” position determination text message will result in the repetition of blocks 122-126 every “N” minutes. If no time interval is specified, the personal locator device can automatically use a default interval. A subsequent cancellation text message can be used to terminate the position determinations, or the personal locator device can be manually reset.

Referring again to FIG. 7, if a text message is identified as an audible indication text message at block 114, the personal locator device will play an audio file corresponding to the text message at block 136. Unless a text message requiring further action is received, the method ends at block 130. Referring again to FIG. 8, the audio file can include spoken commands, such as “Home,” “Speak” or “Stay.” Advantageously, these audio files can feature the voice of a person familiar to the user hearing the command. Additionally, an audio file can be an alert tone, allowing personnel searching for the user to better pinpoint the precise location once within the vicinity of the personal locator device. A time interval “N” can also be specified for the alert tone, or a default interval can be used. If the location of the remote position monitoring device is also known, the alert tone can automatically be triggered once the personal locator device is within a predetermined range; for instance, a range corresponding the maximum distance at which the alert tone can be heard.

Referring again to FIG. 7, if the text message is identified as status reporting text message at block 114, a status determination is made at block 142. At block 144, a status reporting text message is generated. The status reporting text message is transmitted at block 146. Unless a text message requiring further action is received, the method ends at block 130. Referring again to FIG. 8, exemplary types of status determination text messages include messages inquiring into the status of the user and messages inquiring into the status of the personal locator device. As described above, status reporting messages in response to inquiries into the status of the user can include fanciful statuses that are randomly determined, or statuses based on sensed physiological data from the user. Status reporting messages in response to inquiries into the status of the personal locator device include information relating to the device parameters, such as battery power remaining.

It will be appreciated that the foregoing method, or portions thereof, can be repeated as required or desired, and that steps of the method can be performed in any logical order, in series or in parallel. Additionally, not every iteration of the method will require all of the steps described, and additional steps can be added while remaining within the scope of the present invention.

Advantageously, embodiments of the present invention can provide a personal locator device that is easily carried, while still capable of functioning for extended periods of time without connection to any external power supply. Additionally, the present invention can potentially provide a personal location monitoring system that uses existing communications networks and data formats, allowing for utilization in connection with readily available personal electronic devices and components thereof. Also, the present invention can allow for utilization of existing prepaid, or pay-as-you go, networks, to obviate the need for potentially prohibitive subscription fees.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. A personal locator device comprising:
a portable housing;
a wireless communications unit carried by said portable housing and configured to communicate via text messages over a wireless communications network;
a position determining unit carried by said portable housing and configured to receive position signals from a positioning system; and
a processor carried by said portable housing and in signal communication with the wireless communications unit and the position determining unit, the processor being configured to
receive a position determination text message via the wireless communications unit, and
send at least one position reporting text message via the wireless communications unit responsive to the position determination text message including position data based on the position signals received by the position determining unit.

2. The personal locator device of claim 1, further comprising:
at least one expansion port carried by said housing and coupled to said processor; and at least one expansion device configured to be coupled to said expansion port.

3. The personal locator device of claim 2 wherein said at least one expansion device comprises at least one of an expansion battery, a solar power unit, a kinetic power unit, a speaker unit, and an expansion memory unit.

4. The personal locator device of claim 1, further comprising a speaker unit and a memory unit carried by said portable housing and in signal communication with the processor, the memory unit having a plurality of audio files stored thereon, each of the stored audio files corresponding to a respective audible indication text message, and the processor being further configured to cause the speaker unit to selectively play a respective stored audio file upon receipt of the audible indication text message corresponding thereto.

5. The personal locator device of claim 1, further comprising a memory unit carried by said housing and in signal communication with the processor, the memory unit having a plurality of different status report text messages stored thereon, and the processor being further configured to selectively send the status report text messages upon receipt of respective status determination text messages.

6. The personal locator device of claim 1, further comprising a physiological sensor in signal communication with the processor, the processor being further configured to initiate at least one physiological measurement by the physiological sensor and send at least one physiological status text message via the wireless communications unit including at least one determined physiological measurement.

7. The personal locator device of claim 1, wherein at least one position reporting text message comprises a plurality of successive position reporting text messages, and wherein said processor is configured to include updated position data in the successive position reporting text messages.

8. The personal locator device of claim 1, further comprising a collar carrying said portable housing.

9. The personal locator device of claim 1, wherein the text messages comprise short message service (SMS) text messages.

10. The personal locator device of claim 1, wherein the processor initiates a position determination in response to the position determination text message to generate at least one set of position data.

11. A personal location monitoring system comprising:
a personal locator device comprising
a portable housing,
a wireless communications unit carried by said portable housing and configured to communicate text messages over a wireless communications network,
a position determining unit carried by said portable housing and configured to receive position signals from a positioning system, and
a processor carried by said portable housing and in signal communication with the wireless communications unit and the position determining unit, the processor being configured to
receive a position determination text message via the wireless communications unit, and
send at least one position reporting text message via the wireless communications unit responsive to the position determination text message including position data based on the position signals received by the position determining unit; and
a remote location reporting device configured to send the position determination text message and to receive at least one position reporting text message.

12. The system of claim 11, wherein the remote location reporting device comprises a cellular transceiver.

13. The system of claim 12, wherein the personal locator device and the remote location monitoring device communicate with short message service (SMS) text messages.

14. The system of claim 11, wherein location coordinates of the personal locator device are determined by the remote location reporting device based on the position reporting text message.

15. The system of claim 11, wherein location coordinates of the personal locator device are determined by the personal locator device and included in the position reporting text message.

16. The system of claim 11, wherein at least one position reporting text message comprises a plurality of successive position reporting text messages, and wherein said processor is configured to include updated position data in the successive position reporting text messages.

17. A method of using a personal locator device, the method comprising:
receiving, over a wireless network, a position determination text message at the personal locator device;
determining position data from position signals received at the personal locator device;
generating a position reporting text message in response to the position determination message including the position data; and
sending the position reporting text message over the wireless network.

18. The method of claim 17, further comprising identifying the position determination text message by comparison with a table of text messages stored in the personal locator device.

19. The method of claim 17, further comprising the personal locator device selectively playing at least one stored audio file in response to receipt of an audible indication text message corresponding thereto.

20. The method of claim 17, further comprising the personal locator device selectively sending at least one status report text messages in response to receipt of a status determination text message.
